(19) United States
(12) Patent Application Publication
(10) Pub. No.: US 2013/0040164 A1
(43) Pub. Date: Feb. 14, 2013

(54) Trivalent Chromium Conversion Coating Pre-Coating Treatment

(71) Applicants: Promila P. Bhaatia, Farmington, CT (US); Gary M. Lomasney, Glastonbury, CT (US); Uvauhn S. Mason, Lebanon, CT (US)

(72) Inventors: Promila P. Bhaatia, Farmington, CT (US); Gary M. Lomasney, Glastonbury, CT (US); Uvauhn S. Mason, Lebanon, CT (US)

(73) Assignee: UNITED TECHNOLOGIES CORPORATION, Hartford, CT (US)

(21) Appl. No.: 13/206,874

(22) Filed: Aug. 10, 2011

(51) Int. Cl. B32B 15/01; B05D 1/18; B05D 5/00; B05D 7/14; B05D 3/10; B05D 3/12

(52) U.S. Cl. 428/651; 427/305; 427/292

(57) ABSTRACT

In a method for coating a copper-containing aluminum alloy, the alloy is treated with a solution of at least one polyamino carboxylic acid ligand. A trivalent chromium coating is thereafter applied.

### BACKGROUND

The disclosure relates to chromium conversion coating of copper-containing aluminum alloys. More particularly, the disclosure relates to pre-coating treatments of the alloy substrates.

Hexavalent chromium based conversion coatings have been used on copper containing high strength aircraft aluminum alloys, viz. Al 2xxx or 7xxx for superior corrosion protection. In recent years, efforts have been ongoing to qualify trivalent chromium based conversion coatings to replace hexchrome conversion coatings. As an example, see U.S. Pat. No. 7,018,486 issued Mar. 28, 2006, the disclosure of which is incorporated in its entirety herein as if set for the at length.

### SUMMARY

One aspect of the disclosure involves a method for coating a copper-containing aluminum alloy. The alloy is treated with a solution of at least one polyamino carboxylic acid ligand. A trivalent chromium coating is applied.

In various implementations, the ligand may be a hexadentate ligand. The ligand may be EDTA. The solution may have a EDTA concentration of 200-2000 ppm. The treating may comprise immersion for at least five minutes (e.g., 5-30 minutes). The treating may be equivalent to at least ten minutes immersion with the solution at 500 ppm (e.g., for a duration and with a solution concentration effective to provide at least a similar effect). The alloy may have at least 3% copper, by weight. The applying of the trivalent chromium coating may involve contacting with a coating solution for a total contact time of at least fifteen minutes (e.g., 15-30 minutes). The alloy may be cleaned and then coated with said trivalent chromium coating as a trivalent chromium-phosphate (TCRP) chemical conversion coating. Prior to the treatment with the EDTA solution, the alloy may be chemically deoxidized and/or cleaned by mechanically abrading. The chemical deoxidizing may comprise treating with nitric acid.

The details of one or more embodiments are set forth in the accompanying drawings and the description below. Other features, objects, and advantages will be apparent from the description and drawings, and from the claims.

### BRIEF DESCRIPTION OF THE DRAWINGS

FIG. 1 is a SEM/EDS spectrum of an Al 2024 test sample immersion treated with 500 ppm of EDTA for ten minutes without TCRP coating.

FIG. 2 is a SEM/EDS spectrum of an Al 2024 test sample immersion treated with 500 ppm of EDTA for ten minutes and then brush coated with TCRP for twenty minutes followed by a brush touch-up at a five minute interval thereafter.

Like reference numbers and designations in the various drawings indicate like elements.

### DETAILED DESCRIPTION

Copper additions are made to aircraft aluminum alloys to improve the strength. This strength is due to the formation of copper-rich intermetallic particles. However, these intermetallic particles promote pitting or localized corrosion due to a galvanic couple that is formed between copper-rich intermetallic and the copper-depleted aluminum matrix. In addition, literature also reports that surface composition and thickness variation has been noted in conversion coatings over intermetallic regions.

However, all the historical data on corrosion performance collected on AA 2024 aluminum alloy has shown that these trivalent coatings do not provide corrosion protection equivalent to hexavalent coatings, in particular when the surface preparation of the alloy is done by deoxidizing

The present disclosure involves applying a chemical solution as a surface pre-treatment that will modify the aluminum alloy surface and would thereby help in improving corrosion resistance properties of trivalent chromium conversion coatings.

The chemical solution that was used as a pretreatment for surface optimization was Ethylenediaminetetra-acetic acid, commonly known as EDTA. EDTA is a member of the polyamino carboxylic acid family of ligands, and is also called a hexadentate ligand. Other candidates are: bidentate ligands like ethylenediamines or polyethyleneamines; and polydentate or hexadentate ligands like EDTA and its salts.

EDTA-4 usually binds to a metal cation through its two amines and four carboxylates, and therefore can form multiple bonds with a single metal ion because of its role as a chelating agent or its ability to “sequester” metal ions such as Cr (III), Fe (III), Cu (II), Ca (II), and the like, to form stable metal complexes. The EDTA molecule seizes the metal ion as if with a claw, and keeps it from reacting (metal ions, after being bound by EDTA, exhibit diminished reactivity).

It is thought that EDTA is tying up copper-containing particles owing to its markedly higher adsorption strength on copper surfaces.

A study was performed on Al 2024 test samples. The trivalent chromium coating chosen for this study was a trivalent chromium-phosphate of U.S. Pat. No. 7,018,486. This phosphate contains nitrilotris (methyelene) triphosphonic acid as a hydration inhibitor.

In experiments, Al 2024 test samples received initial surface preparation by one of the three different methods. The three different methods were: a) mechanically abrading using Scotch-Brite™ pads; b) chemically deoxidizing with Turco Smut-Go™ non-chromate deoxidizer (test samples were immersed in deoxidizing solution for two to five minutes at room temperature and then rinsed or power washed using tap water); and c) chemically deoxidizing using 50% nitric acid as a deoxidizing agent (test samples were immersed in 50% nitric acid solution for two to five minutes at room temperature and then rinsed or power washed using tap water).

The samples were immersion pretreated with EDTA at two alternative concentrations: 500 & 1000 ppm. The contact time with EDTA was for ten and twenty minutes at these two concentrations.

The samples were then thoroughly cleaned using tap water, and then coated with trivalent chromium-phosphate (TCRP) chemical conversion coating. TCRP coating was applied either by brush touch-up or by immersion method. The contact time for both application methods was twenty to thirty minutes.

Test samples were then exposed to ASTM B117 salt spray test for corrosion properties. Test samples were also prepared for SEM/EDS testing to understand if there was any deposition and/or reaction of the Al 2024 surface with the EDTA.

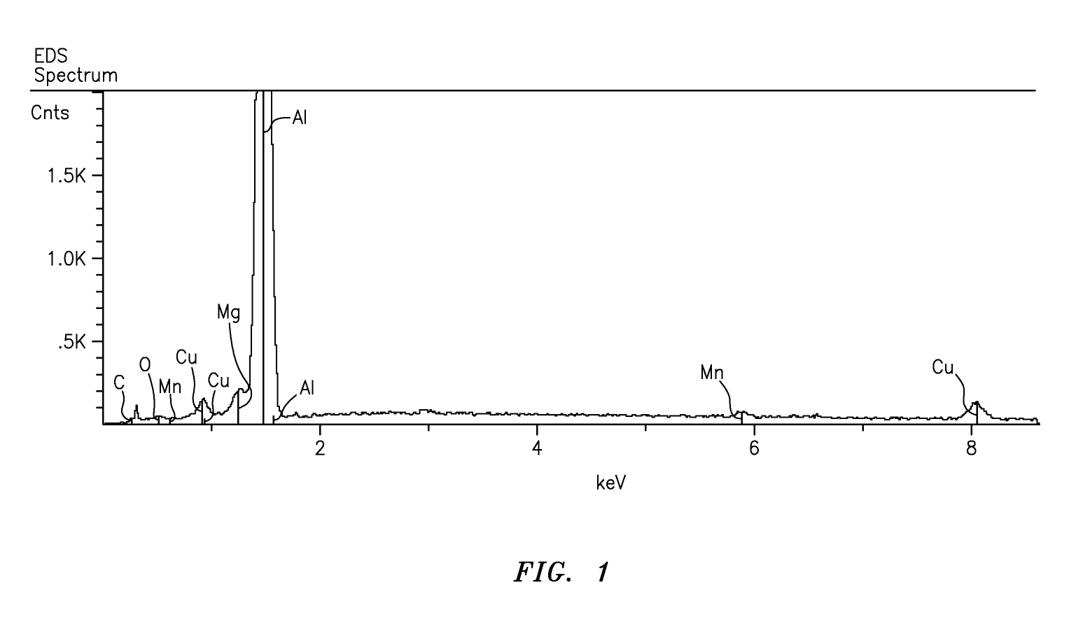

Salt spray test results showed considerable improvement. Test samples showed no signs of corrosion in the 500-hour salt spray test. The SEM/EDS spectrum of FIG. 1 showed the presence of carbon and oxygen, indicating some kind of reaction or deposition of EDTA molecules on the Al 2024 substrate.

Table I shows test results for 500 hours ASTM B117 salt spray test. Tests were performed on five test specimens per batch or test parameter. In contrast, a baseline (the same process without EDTA) shows corrosion resistance of about 200 to 250 hours in the salt fog spray test.

TABLE I
Salt Spray Test Results - Al 2024 Test Alloy -
EDTA Pre-treated and TCRP Conversion Coated

| Hours | 500 ppm | | 1000 ppm | |
|---|---|---|---|---|
| in salt | 10 minutes | 20 minutes | 10 minutes | 20 minutes |
| spray | contact time | contact time | contact time | contact time |
| 168 | Good | Good | Good | Good |
| | condition | condition | condition | condition |
| 336 | Good | Good | Good | Good |
| | condition on | condition on | condition on | condition on |
| | 3 panels, | 3 panels, | 3 panels, | 3 panels, |
| | >5 < 25 | >5 < 25 | >5 < 25 | >5 < 25 |
| | white | white | white | white |
| | corrosion | corrosion | corrosion | corrosion |
| | spots on 2 | spots on 2 | spots on 2 | spots on 2 |
| | panels | panels | panels | panels |
| 500 | >25 white | >25 white | Good | >25 white |
| | corrosion | corrosion | condition on | corrosion |
| | spots on all | spots on all | 2 panels, | spots on all |
| | 5 panels | 5 panels | >25 white | 5 panels |
| | | | corrosion | |
| | | | spots on 3 | |
| | | | panels | |

TABLE II
Salt Spray Test Results - Al 2024 Test Alloy Chemically
Deoxidized and Pre-treated with 500 ppm EDTA for 20 Minutes
Contact Time (Triplicate Samples Prepared)

| Hours | | Deoxidizing in |
|---|---|---|
| in salt | Deoxidizing in Turco | 50% Nitric Acid |
| spray | Smut-GO Solution | Solution |
| 168 | Good condition | Good condition |
| 336 | >5 < 25 white corrosion | >5 < 25 white corrosion |
| | spots with small trails | spots with small trails |
| | on all 3 panels | on all 3 panels |
| 500 | >5 < 40 tiny pits with small | >5 < 30 tiny pits with small |
| | trails and white corrosion | trails and white corrosion |
| | deposit on the pit | deposit on the pit |

More broadly, other Al alloys may be used. For example, Table III shows candidates:

TABLE III

| | Alloy and weight percentages | | | | |
|---|---|---|---|---|---|
| Element | 2024 | 2014 | 6061 | Range 1 | Range 2 |
| Al | 90.7-94.7 | 90.7-94.7 | 95.8-97.16 | 85+ | 90+ |
| Cr | Max 0.1 | 0.10 | 0.04-0.35 | — | Max 0.5 |
| Cu | 3.8-4.9 | 3.9-5.0 | 0.15-0.40 | 0.15-6.0 | 0.35-5.5 |
| Fe | Max 0.5 | 0.7 | 0.7 | — | Max 1.0 |
| Mg | 1.2-1.8 | 0.20-0.8 | 0.8-1.2 | 0.2-2.5 | 0.2-2.0 |
| Mn | 0.3-0.9 | 0.40-1.2 | 0.15 | 0.1-1.5 | 0.2-1.2 |
| Si | Max 0.5 | 0.50-1.2 | 0.40-0.8 | — | Max 1.0 |
| Ti | Max 0.15 | 0.15 | 0.15 | — | Max 0.25 |
| Zn | Max 0.25 | 0.25 | 0.25 | — | Max 0.5 |
| Other, | Max 0.05 | 0.05 | 0.05 | — | Max 0.1 |
| each | | | | | |
| Other, | Max 0.15 | 0.15 | 0.15 | — | Max 0.2 |
| total | | | | | |

An alternative characterization of the applicable alloys may involve an aluminum-based alloy (e.g., 50+% by weight, more narrowly, 85+% by weight or 90+% by weight) with at least 3.0% by weight copper (more narrowly, 3.5-5.5%) and no other element having a greater content, by weight, than the copper content. This range includes the 2024 and 2014 series noted above but excludes the 6061 series. Additionally, an exemplary range of EDTA concentration is 200-2000 ppm. An exemplary exposure is for ten to twenty minutes in duration. Exemplary exposure is at least equivalent to exposure at 500 to 1000 ppm for ten to twenty minutes in duration.

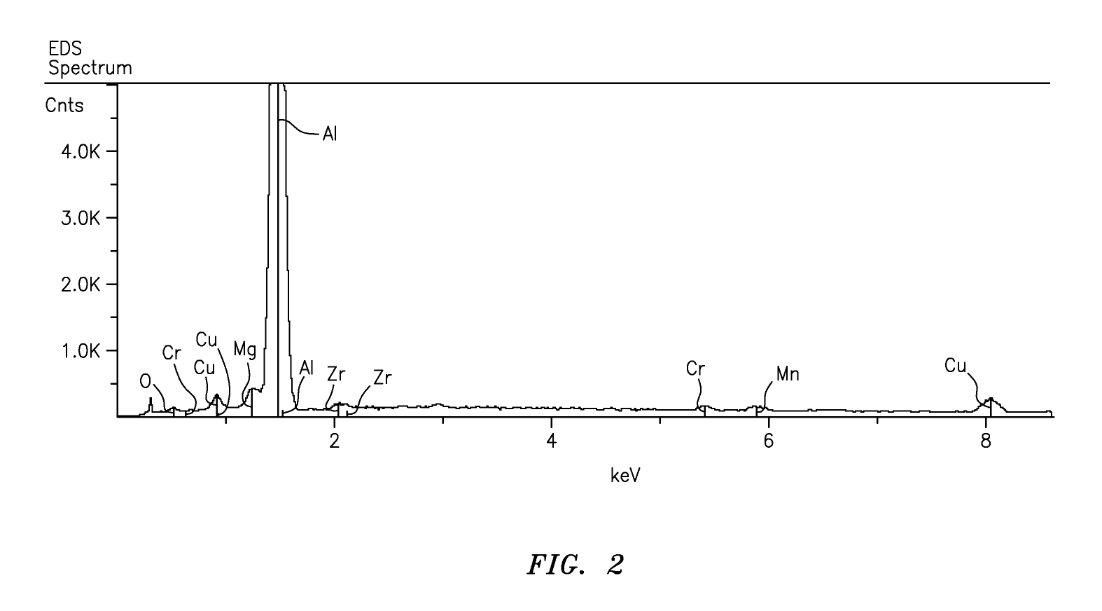

Conversion coating was applied by brush touching-up for total of twenty minutes contact time so that the surface remains wet through out the coating time. The solution was applied over again and again at the interval of four to five minutes. Among possible variations in the coating process are immersion (dipping), spraying, and non-brush touch-up (e.g., swabbing). The resulting chemistry is difficult or impractical to determine. We cannot tell for certain whether the EDTA became an integral part of the trivalent chrome coating. It is difficult to detect this effect because the EDTA pretreatment creates, perhaps, a monolayer thickness, and such thin layers are difficult to detect in SEM/EDS. In addition, carbon and oxygen, being lighter elements, do not give a strong signal (this difficulty is evident in SEM/EDS where carbon, which is seen in FIG. 1, is not seen in FIG. 2).

One or more embodiments have been described. Nevertheless, it will be understood that various modifications may be made. Accordingly, other embodiments are within the scope of the following claims.

1. A method for coating a copper-containing aluminum alloy, the method comprising:
treating the alloy with a solution of at least one polyamino carboxylic acid ligand; and
applying a trivalent chromium coating,
wherein:
the solution consists essentially of a hexadentate ligand solution.

2. (canceled)

3. The method of claim 1 wherein:
the solution comprises or consists essentially of an EDTA solution.

4. The method of claim 1 wherein:
the alloy is cleaned prior to the treating; and
the treated alloy is coated with said trivalent chromium coating as a trivalent chromium-phosphate (TCRP) chemical conversion coating.

5. The method of claim 1 wherein:
the solution has an EDTA concentration of 200-2000 ppm.

6. The method of claim 1 wherein:
the treating comprises immersion for at least five minutes.

7. The method of claim 6 wherein:
the immersion is 5-30 minutes.

8. The method of claim 1 wherein:
the treating is equivalent to at least ten minutes immersion with the solution at 500 ppm.

9. The method of claim 1 wherein:
the aluminum alloy has at least 3.0% copper, by weight.

10. The method of claim 1 further comprising:
prior to the treating, cleaning the alloy via mechanical abrading.

11. The method of claim 1 wherein:
the applying involves contacting with a coating solution for total contact time of fifteen to thirty minutes.

12. The method of claim 1 further comprising:
a chemical deoxidizing prior to the treating.

13. An article coated by the process of claim 1.

14. A method for coating a copper-containing aluminum alloy, the method comprising:
treating the alloy with a solution of at least one polyamino carboxylic acid ligand; and
applying a trivalent chromium coating,
wherein:
the alloy is cleaned prior to the treating; and
the treated alloy is coated with said trivalent chromium coating as a trivalent chromium-phosphate (TCRP) chemical conversion coating.

15. The method of claim 14 wherein:
the aluminum alloy has at least 3.0% copper, by weight.

16. The method of claim 15 wherein:
the treating is equivalent to at least ten minutes immersion with the solution at 500 ppm.

17. The method of claim 14 wherein:
the treating is equivalent to at least ten minutes immersion with the solution at 500 ppm.

18. A method for coating a copper-containing aluminum alloy, the method comprising:
chemical deoxidizing;
after the chemical deoxidizing, treating the alloy with a solution of at least one polyamino carboxylic acid ligand; and
applying a trivalent chromium coating.

19. The method of claim 18 wherein:
the aluminum alloy has at least 3.0% copper, by weight.

20. The method of claim 19 wherein:
the treating is equivalent to at least ten minutes immersion with the solution at 500 ppm.

21. The method of claim 18 wherein:
the treating is equivalent to at least ten minutes immersion with the solution at 500 ppm.
